(19) United States
(12) Patent Application Publication
(10) Pub. No.: US 2003/0204454 A1
(43) Pub. Date: Oct. 30, 2003

(54) System and method for managing received orders

(76) Inventor: Chih Chung Lai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/277,526

(22) Filed: Oct. 21, 2002

(30) Foreign Application Priority Data
Apr. 30, 2002 (TW) 91108929

(51) Int. Cl. G06F 17/60

(52) U.S. Cl. 705/28

(57) ABSTRACT

A system and method for managing production for received purchase orders according to existing material inventory and production capability. The system interchanges data with a customer management information system (MIS) (4) via an electronic data interchange (EDI) value added network (VAN) (5), and can retrieve production data from an internal MIS (6) for scheduling production for received purchase orders. The system includes an EDI data transceiver (2) for receiving and sending data on orders; an application server (1) electronically connected with the EDI data transceiver for processing the data on orders; and a web server (3) electronically connected with the application server for users to access and manage the data on orders. The application server includes a production scheduling system (11) for scheduling production for received orders, and a database (12) for storing the data on orders and production schedules.

### BACKGROUND OF THE INVENTION

1. Field of the Invention

This invention relates to systems and methods for managing received orders, and more particularly to systems and methods which can schedule production for received purchase orders according to required material inventory and production capability.

2. Description of Related Art

With recent advances in communications technology, traditional methods of data interchange between enterprises are gradually being replaced by the use of electronic data such as electronic data interchange (EDI) and web technology. More and more enterprises are utilizing electronic data to improve their working efficiency and cut down operating costs. One important field concerned is the transmission of purchase and sales order data and cargo shipment data. Such transmission is traditionally accomplished by post or fax. More recently, in a typical transaction, a customer sends purchase order data having a standard EDI format to a supplier. The supplier then schedules production and shipping according to the purchase order data. When the cargo required by the purchase order is manufactured and ready, the supplier sends an EDI shipping information message to the customer. The customer then collects the cargo at a designated place and time.

When receiving a purchase order from a customer, a manufacturer passes the purchase order to production departments that are capable of manufacturing products required by the purchase order. The production departments then notify procurement departments to procure required materials according to the purchase order and according to current material inventory. However, the time required for procurement of materials may be unduly long. In addition, production capability of the production departments is not necessarily taken into consideration when scheduling production for the purchase order.

Moreover, although many enterprises have an independent EDI system for interchanging data with their suppliers and customers, few enterprises integrate their EDI system with their internal management information system (MIS). As a result, scheduling of production and shipping according to current inventory and customers' orders is inconvenient and inefficient.

Accordingly, what is needed is a system and method which can overcome the abovementioned problems.

### SUMMARY OF THE INVENTION

A primary object of the present invention is to provide a system which integrates purchase order data and production data to schedule production for received purchase orders.

Another object of the present invention is to provide a method which integrates purchase order data and production data to schedule production for received purchase orders.

To achieve the above-mentioned primary object, a system of the present invention interchanges data with a customer management information system (MIS) via an EDI value added network, and can retrieve production data from an internal MIS for scheduling production for received purchase orders. The system for managing received orders comprises an EDI data transceiver for receiving and sending data on orders; an application server electronically connected with the EDI data transceiver for processing the data on orders; and a web server electronically connected with the application server for users to access and manage the data on orders. The application server includes a production scheduling system for scheduling production for received orders, and a database for storing the data on orders and production schedules. The production scheduling system includes an order release management module for managing orders released to production departments, a bill of material management (BOM) module for managing BOM data on products, a production process management module for managing data on production processes, a production capability management module for managing production capability data, and a production scheduling module for scheduling production for released orders.

To achieve the other above-mentioned object, a method of the present invention for managing received orders comprises the following steps: receiving data on an order; retrieving BOM data on a product required by the order from an MIS; checking material inventory data in the MIS according to the BOM data; retrieving production process data on the product from the MIS, and checking the production process data; releasing the order for scheduling of production if material inventory and production processes are available; retrieving already-arranged production schedules from the management information system; and scheduling production of the order in light of the already-arranged production schedules.

Other objects, advantages and novel features of the present invention will be drawn from the following detailed description of preferred embodiments of the present invention with attached drawings, in which:

### BRIEF DESCRIPTION OF THE DRAWINGS

FIG. 1 illustrates a framework of hardware of an order management system according to a preferred embodiment of the present invention;

FIG. 2 is a schematic diagram showing data exchange between an application server, a customer MIS and a client computer, all of which are part of the order management system of FIG. 1;

FIG. 3 is a schematic diagram of main function modules of a production scheduling system of the application server of FIG. 1;

FIG. 4 is a flowchart of scheduling production for received purchase orders, according to a preferred embodiment of the present invention;

FIG. 5 is a schematic diagram showing main application modules of a web server of the order management system of FIG. 1; and

FIG. 6 is a flowchart for implementing the order management system of FIG. 1, according to the preferred embodiment of the present invention.

### DETAILED DESCRIPTION OF THE INVENTION

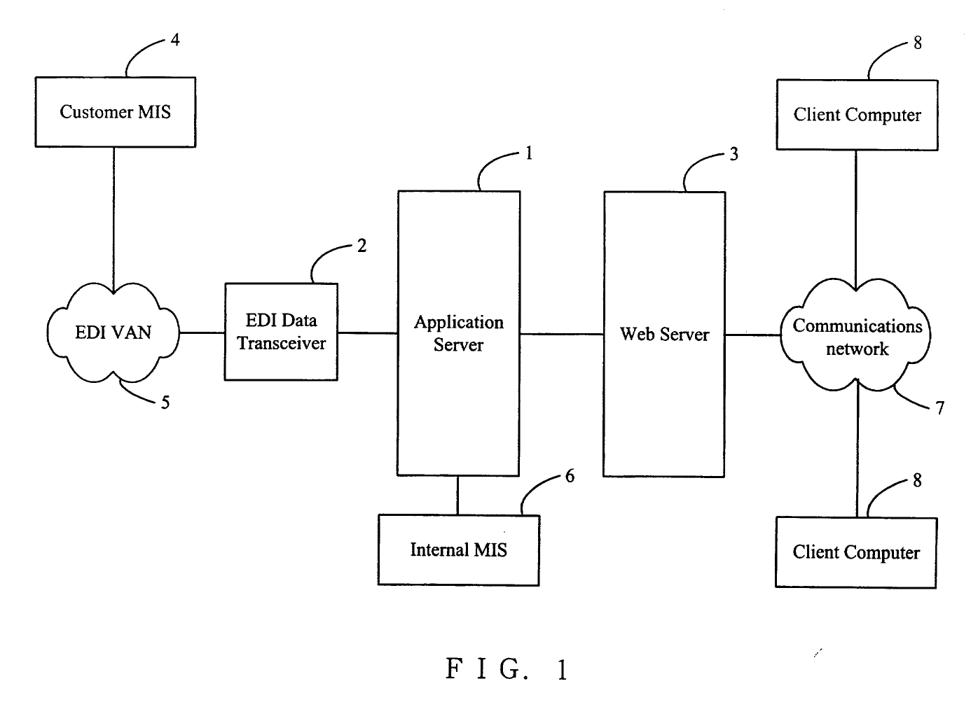

FIG. 1 illustrates a framework of hardware of an order management system according to a preferred embodiment of the present invention. The order management system comprises an application server 1 for processing data on received orders, a web server 3 provided for authorized users to access and manage the data on received orders, and an electronic data interchange (EDI) data transceiver 2 for receiving and sending data on orders. The EDI data transceiver 2 interchanges EDI data with customers' management information systems 4 (MISs 4, only one shown) via an EDI value added network (VAN) 5. The application server 1 is connected to an internal MIS 6, for obtaining production and inventory data. A plurality of client computers 8 can visit the web server 3 via a communications network 7. The communications network 7 can be the Internet or an intranet. The client computers 8 are located in relevant departments of an enterprise implementing the order management system. For the purposes of describing the preferred embodiment, it will be assumed hereinafter that the enterprise implementing the order management system is a manufacturing enterprise. If desired, other client computers 8 can be personal computers of customers, allowing customers to visit the web server 3 via the Internet.

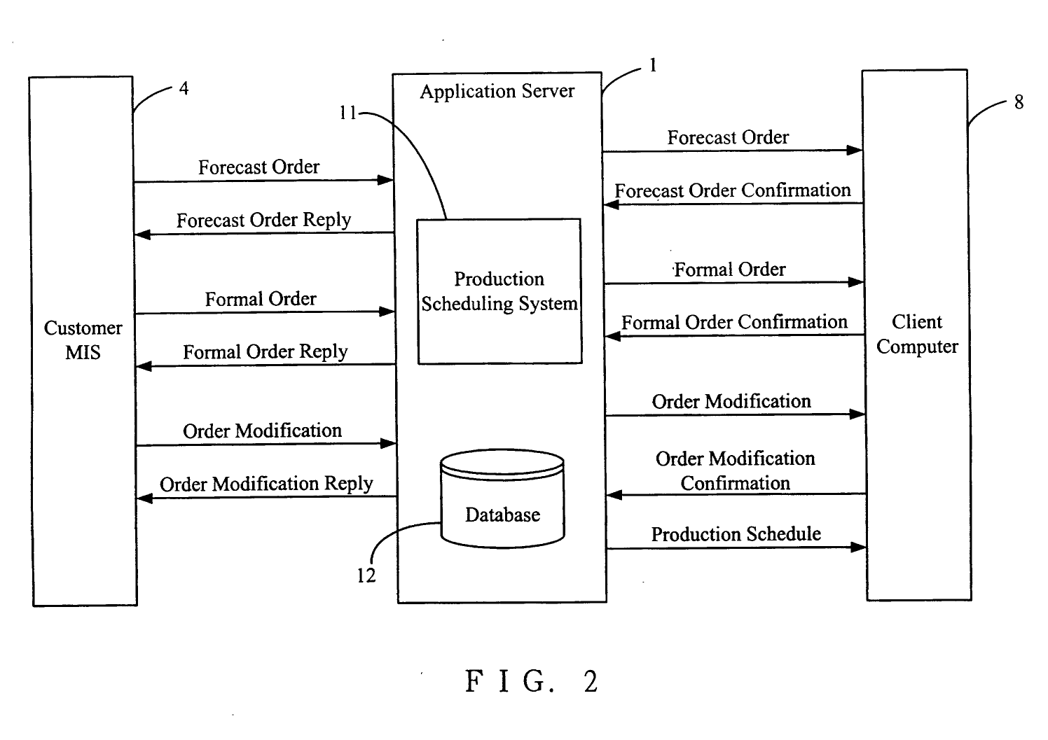

FIG. 2 is a schematic diagram showing data exchange between the application server 1, one customer MIS 4 and one client computer 8. Generally, before a customer issues a formal purchase order, the customer sends data on a forecast order to the order management system via the EDI VAN 5. Production departments of the enterprise can schedule production according to the forecast order, to ensure timely shipment of products according to the corresponding formal purchase order. When data on a forecast order are sent to the order management system, the data on the forecast order are firstly processed in the application server 1. The application server 1 comprises a production scheduling system 11 for scheduling production according to received orders, and a database 12 for storing received order data and scheduled production data. The application server 1 schedules production for the forecast order according to the required materials, production processes and production capability, and sends a production schedule to the client computer 8 of a relevant production department of the enterprise. If the required materials, production processes and/or production capability are not available to fulfill the forecast order, a message on the relevant problem(s) is automatically sent by the application server 1 to the client computer 8 of one or more relevant departments of the enterprise. When the client computer 8 of the relevant production department receives the forecast order data and the production schedule, the relevant production department sends confirmation of receipt of the forecast order to the application server 1. A reply to the forecast order is then sent to the customer MIS 4 by the application server 1. The reply may be confirmation of the forecast order, or may be advice that the forecast order cannot presently be fulfilled. When the reply is confirmation of the forecast order, a formal order confirming the forecast order is sent to the order management system by the customer MIS 4. Thereafter, the formal order is processed by the application server 1 and client computer(s) 8 in similar fashion to processing of the forecast order as described above. If required, the application server 1 adjusts the production schedule to fulfill the formal order. Sometimes an order modification modifying the formal order is sent to the order management system by the customer MIS 4. Thereafter, the order modification is processed by the application server 1 and client computer(s) 8 in similar fashion to processing of the forecast order as described above. The application server 1 adjusts the production schedule to fulfill the formal order in light of the order modification.

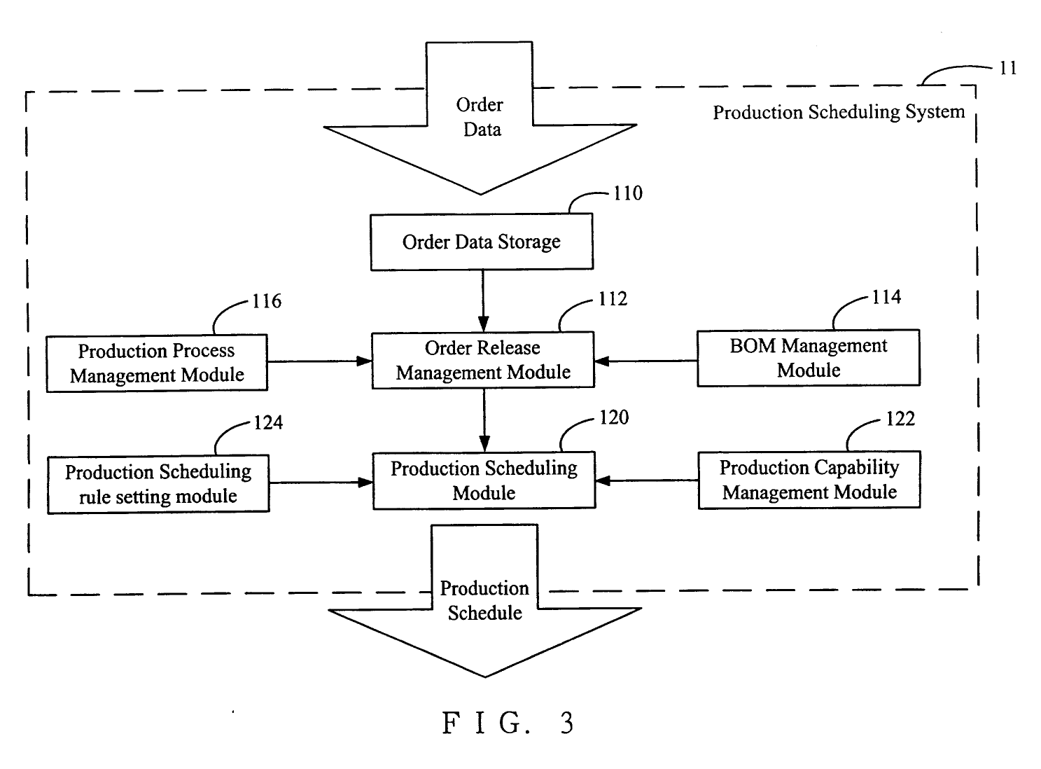

FIG. 3 is a schematic diagram of main function modules of the production scheduling system 11 of the application server 1. The production scheduling system 11 comprises an order data storage 110 for temporarily storing data on received orders, an order release management module 112 for controlling orders released to production departments, a bill of material (BOM) management module 114 for managing BOM data on products, a production process management module 116 for managing production process data, a production scheduling module 120 for scheduling production of released orders, a production capability management module 122 for managing production capability data, and a production scheduling rule setting module 124 for setting and managing rules of production scheduling. The application server 1 is connected to the internal MIS 6, and can retrieve production and inventory data therefrom. When receiving a purchase order, the BOM management module 114 retrieves BOM data on the products required by the purchase order and checks inventory data on the materials listed in the BOM from the internal MIS 6. The production process management module 116 can obtain production process data on the products required by the purchase order, and check to see if all production processes are available in production departments. If the material inventory and the production processes are available, the purchase order is released to production departments. When scheduling production, the production capability management module 122 retrieves already-arranged production schedules from the internal MIS 6, and obtains available production capability data accordingly. The production scheduling rule setting module 124 can be used for setting rules of production scheduling as follows. For example, the production schedule for received orders can be set according to chronological order of shipment dates, or according to the total value of respective received orders.

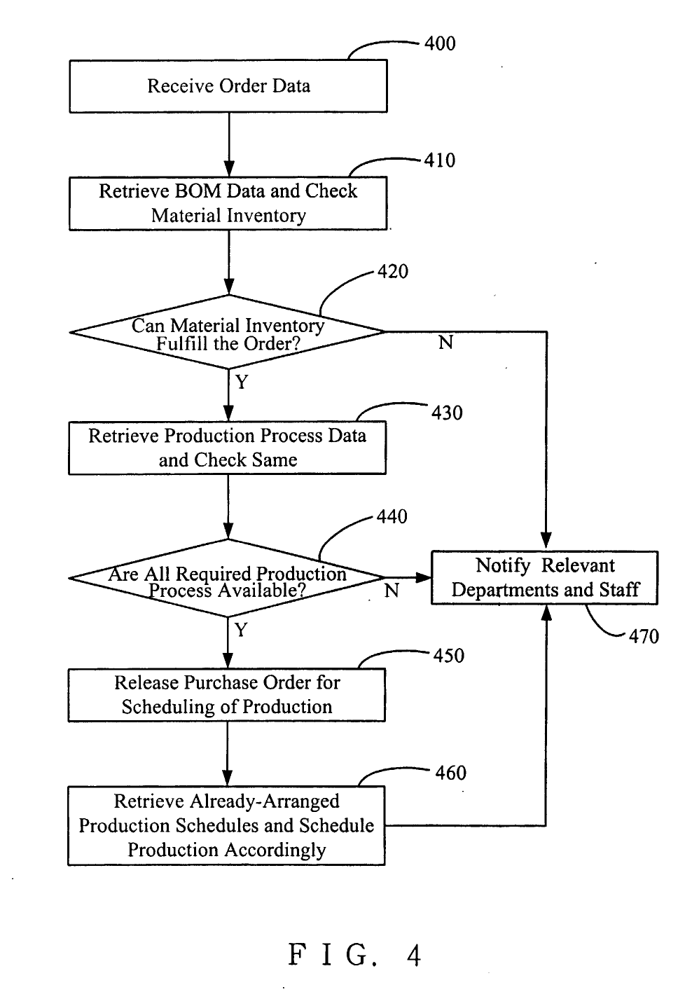

FIG. 4 is a flowchart of scheduling production for received purchase orders, according to a preferred embodiment of the present invention. In step 400, the application server 1 receives a purchase order from the customer MIS 4 via the EDI VAN 5. In step 410, the BOM data on the products required by the purchase order are retrieved from the internal MIS 6, and relevant material inventory is checked according to the BOM data. In step 420, the production scheduling system 11 determines if the material inventory is adequate to fulfill the purchase order. If the material inventory is not adequate to fulfill the purchase order, in step 470, the production scheduling system 11 automatically notifies relevant responsible departments and staff by electronic mail. If the material inventory is adequate to fulfill the purchase order, in step 430, the production scheduling system 11 retrieves production process data from the internal MIS 4 to check all required production processes. In step 440, the production scheduling system 11 determines if the required production processes are available to fulfill the purchase order. If any required production process is unavailable, in step 470, the production scheduling system 11 automatically notifies relevant responsible departments and staff. If all the required production processes are available, in step 450, the purchase order is released to the production scheduling module 120 for scheduling of production. In step 460, the production scheduling system 11 retrieves already-arranged production schedules from all relevant production departments, and schedules production for the purchase order accordingly. In step 470, the finished production schedule is sent to relevant responsible departments and staff.

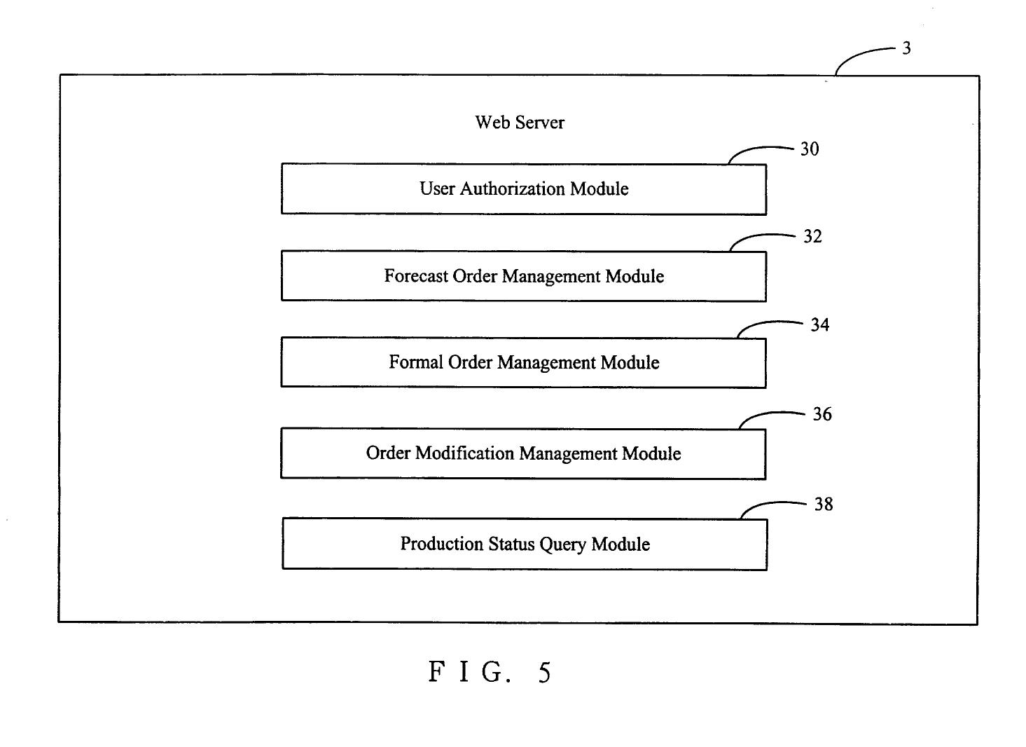

FIG. 5 is a schematic diagram showing main application modules of the web server 3. The web server 3 comprises a forecast order management module 32 for users to query and manage received forecast orders, a formal order management module 34 for users to query and manage received formal orders, an order modification management module 36 for users to query and manage order modifications, a production status query module 38 for users to query production and inventory data, and a user authorization module 30 for system administrators to set access authorization for the said modules 32, 34, 36 and 38. When receiving an order, authorized users confirm or appropriately respond to the order by using the relevant said modules 32, 34, 36 and 38.

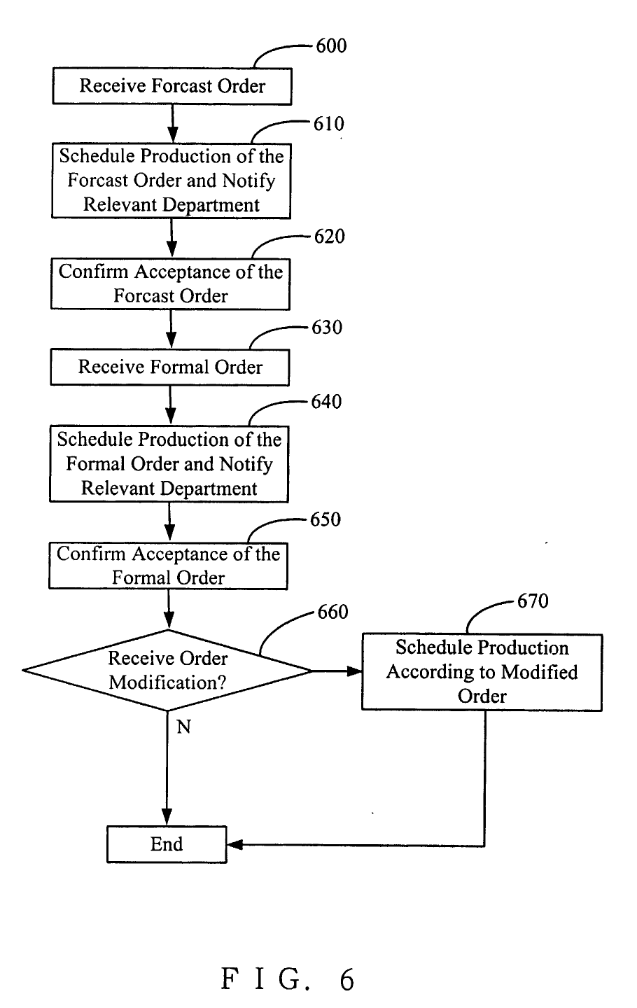

FIG. 6 is a flowchart for implementing the order management system, according to the preferred embodiment of the present invention. In step 600, the order management system receives a forecast order from the customer MIS 4 via the EDI VAN 5. In step 610, the forecast order is scheduled for production by the production scheduling system 11, and automatically sent to the client computer 8 at the relevant responsible department. In step 620, an authorized user confirms acceptance of the forecast order according to the data sent by the order management system. The order confirmation message is sent to the customer MIS 4 by the order management system. In step 630, the order management system receives a formal order corresponding to the forecast order. In step 640, the production scheduling system 11 adjusts the production schedule according to the formal order, and sends data on the formal order and the adjusted production schedule to the client computer 8 of the relevant responsible department. In step 650, an authorized user confirms acceptance of the formal order. In step 660, the order management system checks if the customer MIS 4 has sent an order modification. If an order modification has been sent, in step 670, the production scheduling system adjusts the production schedule to fulfill the order modification. If an order modification has not been sent, the procedure is ended.

The preferred embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for managing received orders, comprising:
an electronic data interchange data transceiver for receiving and sending data on orders;
an application server electronically connected with the electronic data interchange data transceiver for processing the data on orders, the application server including a production scheduling system for scheduling production for received orders and a database for storing the data on orders and production schedules, the production scheduling system including an order release management module for managing orders released to production departments, a bill of material management module for managing bill of material data on products, a production process management module for managing data on production processes, a production capability management module for managing production capability data, and a production scheduling module for scheduling production for released orders; and
a web server electronically connected with the application server for users to access and manage the data on orders.

2. The system as claimed in claim 1, wherein the production scheduling system further comprises a production scheduling rule setting module for setting rules of production scheduling.

3. The system as claimed in claim 1, wherein the production scheduling system further comprises an order data storage for temporarily storing data on received orders.

4. The system as claimed in claim 1, wherein the production scheduling system electronically connects with an internal management information system that manages production data and inventory data of an enterprise.

5. The system as claimed in claim 1, wherein the web server comprises a forecast order management module for users to query and manage received forecast orders, a formal order management module for users to query and manage received formal orders, an order modification management module for users to query and manage order modifications, a production status query module for users to query production and inventory data, and a user authorization module for system administrators to set access authorization for any one or more of said modules of the web server.

6. The system as claimed in claim 1, wherein a plurality of client computers is connected with the web server via a communications network, for accessing the web server.

7. A method for managing received orders, comprising the following steps:
receiving data on an order;
retrieving bill of material data on a product required by the order from a management information system;
checking material inventory data in the management information system according to the bill of material data;
retrieving production process data on the product from the management information system, and checking the production process data;
releasing the order for scheduling of production if material inventory and production processes are available;
retrieving at least one already-arranged production schedule from the management information system; and
scheduling production for the order in light of the at least one already-arranged production schedule.

8. The method as claimed in claim 7, further comprising the step of:
notifying a relevant department if the material inventory or the production processes are not available.

9. The method as claimed in claim 7, further comprising the step of:
notifying a relevant department when production for the order has been scheduled.

10. The method as claimed in claim 7, wherein the management information system is a main information system of an enterprise implementing the order management method, and comprises data on production and inventory of the enterprise.

11. A procedure of managing received orders from a customer, comprising steps of:
receiving a forecast order from management information systems (MIS) of the customer via an electronic data interchange (EDI) value added network (VAN);
scheduling production of the forecast order and notifying relevant departments;
informing said MIS of the customer of confirmation of acceptance of the forecast order via said EDI VAN if every thing is ready;
receiving a formal order from MIS of the customer via said EDI VAN;
scheduling production of the formal order and notifying the relevant departments;
informing said MIS of the customer of confirmation of acceptance of the forecast order via said EDI VAN if every thing is ready;
receiving order modification from MIS of the customer via said EDI VAN, if requested;
rescheduling the production of the formal order according to said order modification.
